(19) United States
(12) Patent Application Publication
(10) Pub. No.: US 2005/0161506 A1
(43) Pub. Date: Jul. 28, 2005

(54) Apparatus for political socio-economic representation

(76) Inventor: Jose Ignacio Gonzalez, Austin, TX (US)

Correspondence Address: Jose Ignacio Gonzalez, #248, 815-A Brazos St., Austin, TX, 78701, US

(21) Appl. No.: 10/762,740

(22) Filed: Jan. 23, 2004

(51) Int. Cl. G06F 17/60

(52) U.S. Cl. 235/386

(57) ABSTRACT

An apparatus that allows citizens to vote from home for a candidate seeking public office by simply pushing a “YES” button next to the candidate's name.

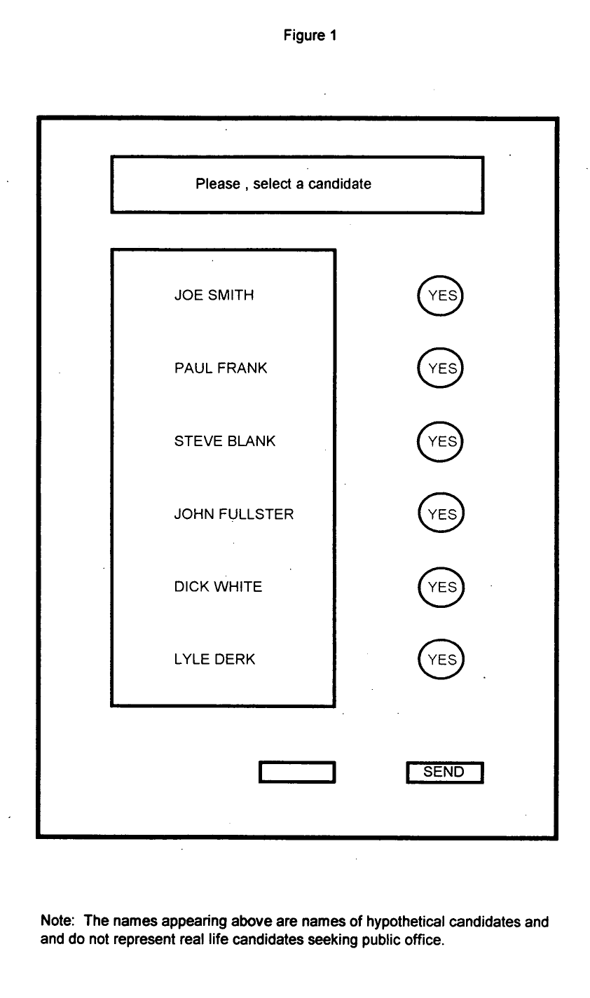

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

When a citizen votes, he or she must leave his or her home, usually get in his or her car and drive several miles to a voting center, usually wait in line, enter a private booth, vote for a candidate seeking to be elected to public office, then get back in his or her car and drive back home. The current process is time consuming and ineffective.

### BRIEF SUMMARY OF THE INVENTION

An apparatus that is physically present in a citizen's or voter's home that lists on a screen the candidates seeking public office and which permits the citizen or voter to vote for one of the candidates by simply pushing a button.

### BRIEF DESCRIPTION OF THE SEVERAL VIEWS OF THE DRAWING

A square with two screens, one on the top and the other along center, right. The former screen reads the command “Please, select a candidate” and the latter one reads the names of each of the candidates seeking public office. Along each candidate's name, on the right, is a “YES” for each candidate. Below the “YES” buttons is a “SEND” button and on its left is a “CANCEL” button.

### DETAILED DESCRIPTION OF THE INVENTION

A square machine with a rectangular screen where a list of candidates competing among each other for the same governmental post appears in bright letters. Next to each candidate's name appears one button with the word “YES” written on it. The elector or voter selects, first, the candidate he or she wishes to elect to office, and then presses the “YES” button, right next to the candidate's name. On a top rectangular screen then appears the words “You have selected candidate . . . ”. The name of the candidate appears next to the word candidate. The voter would then press one of two buttons; either a button with the word “SEND” in which case the information, that the voter has conveyed to the machine, his “YES” vote on one of the candidates listed, is then sent via the internet to a file server, which records the voter's vote, and relays this information to a computer in an office where the vote is tallied to the right citizen, the one who voted; or a button with the word “CANCEL” written on it, in which case, the voter would be prompted again in the upper rectangular screen, to “Please, select a candidate”. The voter would go through the same process again till he presses the button “SEND”. After the voter presses the button “SEND”, the message atop in the rectangular screen would read “Thank you for voting”.

1. I claim an apparatus that permits citizens to vote for a candidate seeking to be elected to public office from the comfort of their home or office by transferring voter information from the home or office where the apparatus rests to a central tallying office that records each voter's vote by matching his or her identification number with his or her name.
